(19) United States
(12) Patent Application Publication
(10) Pub. No.: US 2016/0241290 A1
(43) Pub. Date: Aug. 18, 2016

(54) CELL PHONE CASE WITH CHARGING CAPABILITIES

(71) Applicants: Muhnad Alshammari, Columbus, OH (US); Faisal Alotaibi, Columbus, OH (US); Ayyad Alotaibi, Columbus, OH (US)

(72) Inventors: Muhnad Alshammari, Columbus, OH (US); Faisal Alotaibi, Columbus, OH (US); Ayyad Alotaibi, Columbus, OH (US)

(21) Appl. No.: 14/623,752

(22) Filed: Feb. 17, 2015

(51) Int. Cl. H04B 1/3888; H04B 1/3883

(52) U.S. Cl. CPC H04B 1/3888; H04B 1/3883

(57) ABSTRACT

A cellular phone case that includes: an interior opening, where the interior opening receives a cellular phone; a power connector extending within the interior opening, where the power connector provides a means to connect power to the cellular phone within the interior opening; a cord extending from the power connector and leading into a spool with a second compartment; a USB cord wrapped around the spool within the second compartment; and a USB connector attached to the USB cord, where the USB connector is extendable from the cellular phone case. The cellular phone case preferably also includes a second compartment, where second compartment encloses the spool and USB cord. A back cover may be provided that covers the second compartment.

### BACKGROUND OF THE INVENTION

1. Field of Invention

The present invention relates to a cellular phone case that is used to protect and also charge a cellular phone.

2. Description of Related Art

Cellular phones have now become common communications devices used widely throughout the world. Furthermore recently a considerable number of cellphone users have started using the smartphone style of cellphone. The typical smartphone includes a touch screen that makes the interactivity with the cell phone quite versatile. One drawback to the touch screen is the risk of damage if the phone is dropped. To address this issue numerous companies have developed and made various types of cases that enclose the cell phone and therefore protect it from damage if accidentally dropped. Further cell phones must also maintain a charge on the battery for use. Although battery life has increased significantly smartphones still require charging through a connection to either an active computer, a power adapter or a separate charging unit. Typically the phone is connected to a cord that includes a USB connector. This USB connector is connected either directly to a computer or to a power adapter that is engaged into an AC outlet. Since cell phone cases and charging mechanisms are essential accessories for the Smartphone it would therefore be advantageous to have a device that addresses both of these needs in one component.

### SUMMARY OF THE INVENTION

The present invention relates to a cellular phone case comprising: an interior opening, where the interior opening receives a cellular phone; a power connector extending within the interior opening, where the power connector provides a means to connect power to the cellular phone within the interior opening; a cord extending from the power connector and leading into a spool with a second compartment; a USB cord wrapped around the spool within the second compartment; and a USB connector attached to the USB cord, where the USB connector is extendable from the cellular phone case. The cellular phone case preferably also includes a second compartment, where second compartment encloses the spool and USB cord. A back cover may be provided that covers the second compartment.

### BRIEF DESCRIPTION OF DRAWINGS

FIG. 1 depicts a cellular phone case in accordance with the present invention.

FIG. 2 depicts a reverse or backside surface of the cellular phone case according to the present invention.

FIG. 3 depicts charging mechanisms associated with the cellular case in accordance with the present invention.

### DETAILED DESCRIPTION

The present invention relates to a cellular phone case that is used to enclose and protect a cellular phone. The cell phone case further includes a charging capability where the phone is directly connected to an internal connector and an extended power cord with a USB connector is provided from one side of the cellular phone case. This power cord is stored on a retractable cord spool. The spool is contained within the case along with the cord that connects from the internal connector to the power cord that attaches to the USB connector that extends from the cellular phone case.

The cellular phone case according to the present invention includes an interior portion that receives a cellular phone and an interior connector within the phone. This further backside of the phone conceals a retractable spool that stores a power cord that extends from one side of the cellular phone case.

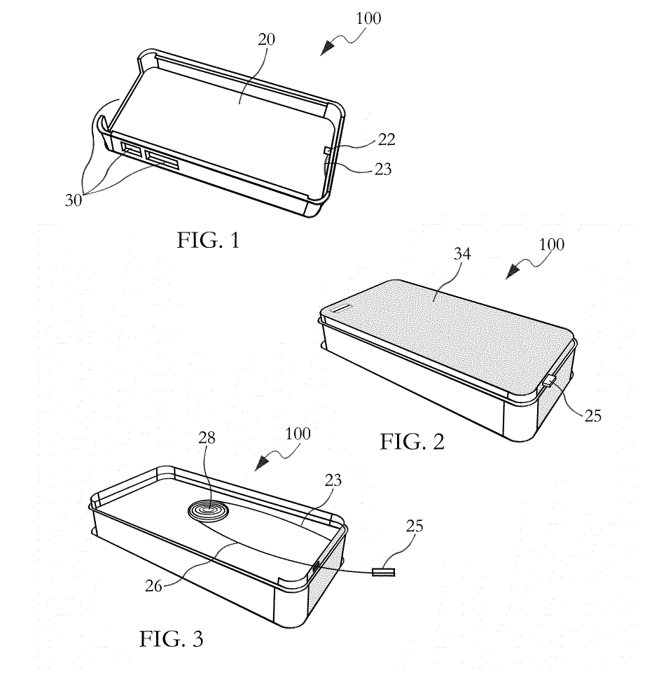

In reference to FIG. 1 a cellular phone case 100 is depicted. The cellular phone case 100 includes an interior 20 with a connector 22 extending within the interior 20. A cord 23 extends from the connector 22. The connector 22 provides a means to connect a cellular phone within the case to a power cord 23. The power cord 23 extends outward into a second compartment within the cellular phone case 100. This second compartment is shown clearly in FIG. 3. As shown in FIG. 3, the second compartment is on the reverse side of the cellular phone case 100. A back cover 34 as shown in FIG. 2 covers this second compartment of the cellular phone case 100. A USB plug 25 extends from the cellular phone case 100 and is more clearly shown in FIG. 3. The USB plug 25 locks within an opening within the cellular phone case 100 when not in use. The power cord 26 extends from a retractable spool 28. The spool holds the cord 26 that connects to the USB plug 25. Power cord 23 extends into the spool and provides connection to the interior connector 22 shown in FIG. 1. This second compartment is contained behind the back cover 34 and therefore is not visible during use.

A user may install their cellular phone within the interior 20 of the cellular phone case 100 and connect the phone at the connector 22. Once in this position the phone may be easily charged by using the USB connector 25 that extends from the spool 28. During use the user pulls the USB plug 25 from the opening and connects to either a power adapter or computer in order to charge the cellular phone. The instant invention has been shown and described in what it considers to be the most practical and preferred embodiments. It is recognized, however, that departures may be made there from within the scope of the invention and that obvious modifications will occur to a person skilled in the art.

1. A cellular phone case comprising:
a. an interior opening, where the interior opening receives a cellular phone within a first compartment;
b. a power connector extending within the interior opening, where the power connector provides a means to connect power to the cellular phone within the interior opening;
c. a second compartment on a reverse side of the interior opening;
d. a cord extending from the power connector and leading into a spool with the second compartment;
e. a USB cord wrapped around the spool within the second compartment; and
f. a USB connector attached to the USB cord, where the USB connector is extendable from the cellular phone case.

2. The cellular phone case according to claim 1, further including the second compartment, where second compartment encloses the spool and USB cord.

3. The cellular phone case according to claim 2, further including a back cover that covers the second compartment.
